(19) United States
(12) Patent Application Publication
(10) Pub. No.: US 2024/0267634 A1
(43) Pub. Date: Aug. 8, 2024

(54) COMPENSATION TECHNIQUES FOR DIFFRACTION PATTERNS CAUSED BY AN APERTURE OF AN IMAGE CAPTURE DEVICE

(71) Applicant: QUALCOMM Incorporated, San Diego, CA (US)

(72) Inventors: Wei-Te Chang, Taipei City (TW); Yi-Chun Hsu, Taipei City (TW); Kai Liu, Taipei (TW); Wei-Chih Liu, Taipei City (TW); Wen-Chun Feng, New Taipei City (TW)

(21) Appl. No.: 18/166,227

(22) Filed: Feb. 8, 2023

(51) Int. Cl. H04N 23/81; H04N 23/11

(52) U.S. Cl. CPC H04N 23/81; H04N 23/11

(57) ABSTRACT

This disclosure provides systems, methods, and devices for image signal processing that support compensating for a diffraction pattern in an image. The diffraction pattern results from blades of a variable aperture of a camera used to capture the image. In a first aspect, a method of image processing includes receiving, by a processor, first image data; determining, by the processor, a characteristic of the first image data correlated with a color temperature of the first image data; determining, by the processor, a compensation matrix based on whether the characteristic exceeds a predetermined threshold, wherein the compensation matrix comprises correction values for reducing red channel peaks in the first image data; and determining, with the computing device, corrected image data based on the first image data and on the compensation matrix. Other aspects and features are also claimed and described.

### TECHNICAL FIELD

Aspects of the present disclosure relate generally to image processing, and more particularly, to image processing for variable aperture camera systems. Some features may enable and provide improved image processing, including compensating for a diffraction pattern caused by an aperture in image data.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

In certain scenes, a photographer may desire to direct the viewer's focus to one portion of the scene. For example, in a portrait photograph of a person, the photographer may desire for the viewer to focus on the person, rather than other scenery. The photographer may choose a low aperture lens for such a photograph, because the low aperture results in objects at different depths than the person to be significantly blurred. Lower aperture lenses produce higher blurring than higher aperture lenses.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

An aperture of a lens may cause a diffraction pattern in captured image data. The diffraction pattern may be more pronounced when the aperture includes many blades that approximate a circular aperture. Blades may be present in a variable aperture lens of an image capture device. Each of the blades has a point at the end of the blade that together create a diffraction pattern in the captured image data. The diffraction pattern distorts the representation of the scene in the image data, which becomes more noticeable with smaller the aperture size. The diffraction pattern is also sensitive to the light used to capture an image.

In some aspects, an image processing method is provided that dynamically compensates for a diffraction pattern in captured image data by reducing the distortion caused by the diffraction pattern in the image data. The diffraction pattern may be due to features of a lens aperture of an image capture device. For example, the image processing method may be used with image capture devices having variable apertures. In various aspects of such examples, the image processing method may be applied when the image capture device captures an image with the variable aperture at an aperture size below a threshold. To perform the dynamic compensation, a characteristic of the color (e.g., color temperature) of captured image data is determined, and based on rules (e.g., whether the characteristic exceeds a threshold), a compensation matrix is determined (e.g., by selecting from at least two predefined compensation matrices) and applied to the captured image data. In at least some aspects, the characteristic of the color of capture image data is determined based on sensor data received from a sensor. In some instances, determining the compensation matrix includes generating an interpolated compensation matrix from the selected compensation matrix. The values in a compensation matrix include correction values for reducing red channel peaks in the image data to smooth out the transitions from values of the image data near minimum values at the center of the image represented by the image data to values of the image data near maximum values at the outmost edges of the image represented by the image data. The determined compensation matrix is used to correct the captured image data based on the correction values in the cells in order to reduce the appearance of the diffraction pattern from the captured image data and determine corrected image data. The corrected image data is thereafter formatted into image frames and output for storage, display, etc.

In one aspect of the disclosure, a method for image processing includes receiving, by a processor, first image data from a camera comprising a variable aperture; determining, by the processor, a characteristic of the first image data correlated with a color temperature of the first image data; determining, by the processor, a compensation matrix based on whether the characteristic exceeds a predetermined threshold, wherein the compensation matrix comprises correction values for reducing one or more artifacts in the first image data resulting from blades of the variable aperture; and determining, by the processor, corrected image data based on the first image data and on the compensation matrix.

In an additional aspect of the disclosure, an apparatus includes at least one processor and a memory coupled to the at least one processor. The at least one processor is configured to perform operations. The operations include receiving first image data from a camera comprising a variable aperture; determining a characteristic of the first image data correlated with a color temperature of the first image data; determining a compensation matrix based on whether the characteristic exceeds a predetermined threshold, wherein the compensation matrix comprises correction values for reducing one or more artifacts in the first image data resulting from blades of the variable aperture; and determining corrected image data based on the first image data and on the compensation matrix.

In an additional aspect of the disclosure, a non-transitory computer-readable medium stores instructions that, when executed by a processor, cause the processor to perform operations. The operations include receiving first image data from a camera comprising a variable aperture; determining a characteristic of the first image data correlated with a color temperature of the first image data; determining a compensation matrix based on whether the characteristic exceeds a predetermined threshold, wherein the compensation matrix comprises correction values for reducing one or more artifacts in the first image data resulting from blades of the variable aperture; and determining corrected image data based on the first image data and on the compensation matrix.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 shows a flow chart of an example method for processing image data to remove a diffraction pattern that results from blades of a variable aperture according to some embodiments of the disclosure.

FIG. 4 is a block diagram illustrating an example processor configuration for image data processing in an image capture device according to one or more embodiments of the disclosure.

FIG. 5 shows an example variable aperture with different aperture sizes according to some embodiments of the disclosure.

FIG. 6 shows an example compensation matrix according to some embodiments of the disclosure.

FIG. 7A is a graph illustrating an example matrix of image data free of a diffraction pattern according to some embodiments of the disclosure.

FIG. 7B is a graph illustrating an example matrix of image data, including a first diffraction pattern, for a first type of light source according to some embodiments of the disclosure.

FIG. 7C is a graph illustrating an example matrix of image data, including a second diffraction pattern, for a second type of light source according to some embodiments of the disclosure.

FIG. 8 is a graph illustrating an example diffraction artifact, included in the matrix of FIG. 7C, for correction by a compensation matrix.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for dynamically compensating for a diffraction pattern in captured image data resulting from blades of a variable aperture. A characteristic corresponding to the color temperature of captured image data is determined and a compensation matrix is determined based on the characteristic to provide an appropriate correction for diffraction caused by the light source entering the aperture. The compensation matrix is then used to correct the captured image data to reduce the appearance of a diffraction pattern from the captured image data.

Particular implementations of the subject matter described in this disclosure may be implemented to realize one or more of the following potential advantages or benefits. In some aspects, the present disclosure provides techniques for reducing distortion in image data caused by diffraction effects resulting from blades of a variable aperture. As such, the present disclosure provides for higher quality images that are captured with a camera having a variable aperture. Diffraction effects, and therefore image distortion, can increase when the aperture size of a variable aperture decreases, and thus the present disclosure is particularly beneficial for increasing image quality when capturing images with a variable aperture at a small aperture size (e.g., f/4.0), though can be beneficial for all aperture sizes of a variable aperture. Improving the quality of images at smaller apertures by reducing artifacts caused by the variable aperture makes the variable aperture camera more desirable by providing higher quality small-aperture images that approach or exceed the quality of a fixed aperture camera at the same aperture size, while providing the flexibility of also capturing images at a larger aperture size by using the blades to adjust the aperture size.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

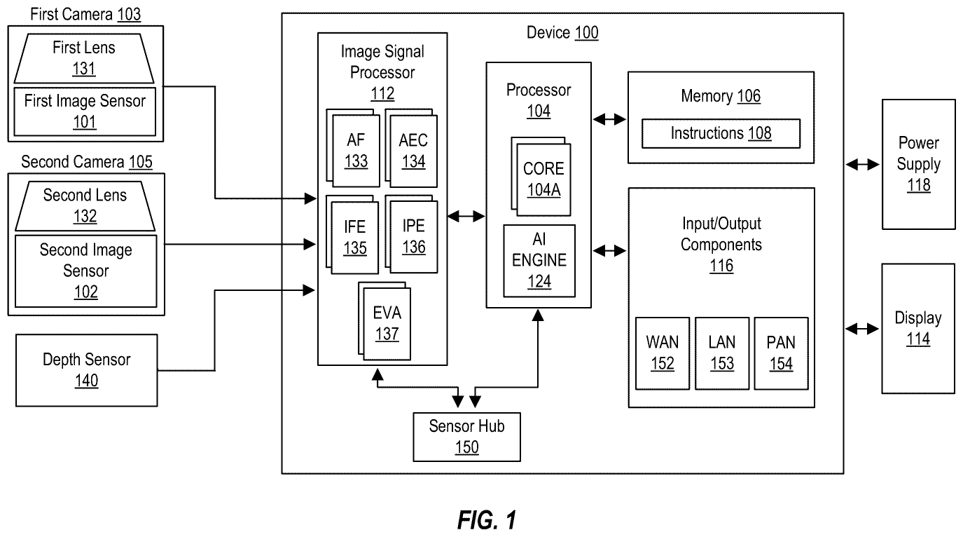

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

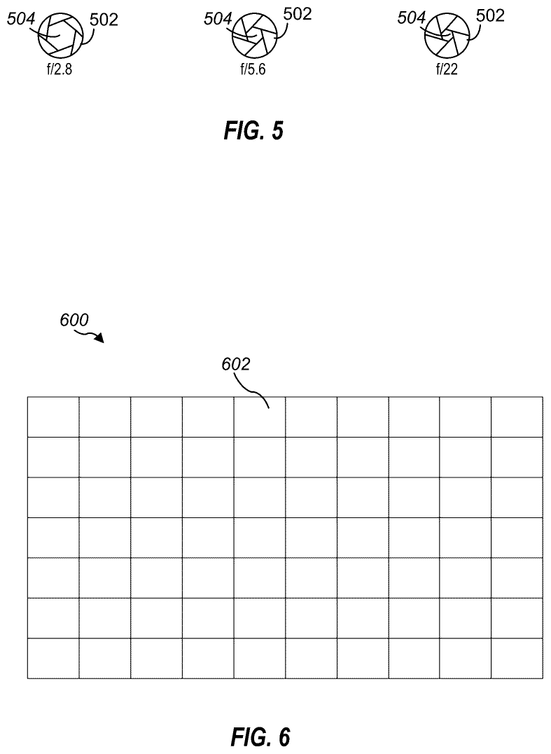

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. FIG. 5 illustrates an example variable aperture 500 at aperture sizes of f/2.8, f/5.6, and f/22. Each example variable aperture includes multiple blades 502 that may be adjusted to change the size of an opening 504 of the aperture. The camera 103 may have different characteristics based on the current aperture size, such as a different depth of focus (DOF) at different aperture sizes.

Returning to FIG. 1, the image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. Example image sensors include RGB (e.g., Bayer) sensors, multi-spectrum sensors, and infrared (IR) sensors. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), laser, and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including diffraction pattern elimination operations. For example, execution of the instructions can instruct the image signal processor 112 to begin or end capturing an image frame or a sequence of image frames, in which the capture includes diffraction pattern elimination as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

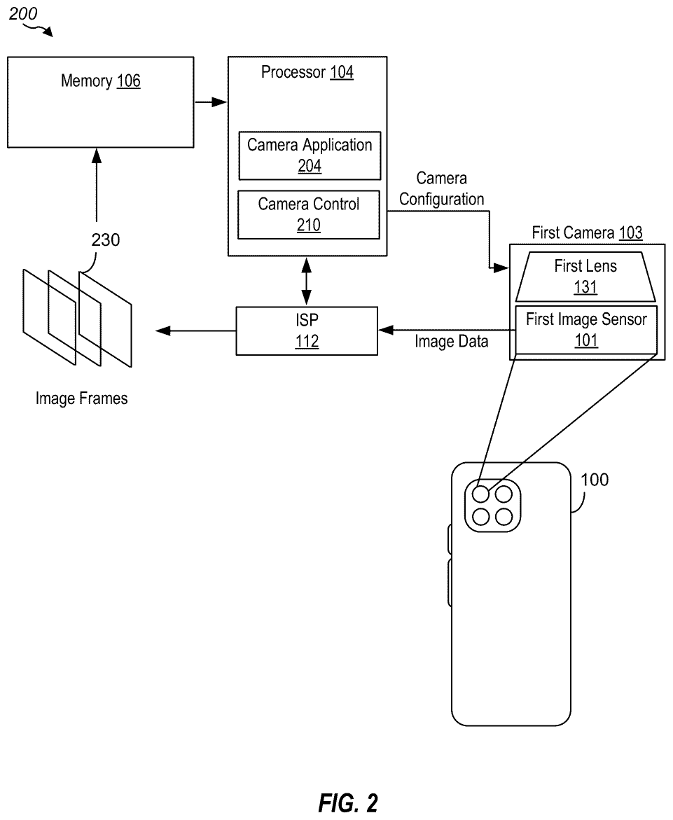

The exemplary image capture device of FIG. 1 may be operated to obtain improved images by processing image data to determine corrected image data that compensates for a diffraction pattern included in the image data. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data captured from camera 103.

The camera configuration may include parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, capture first image data from the camera 103, instruct camera 103 to configure to a second aperture size, and capture second image data from the camera 103. The reconfiguration of the aperture and capturing of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The ISP may perform some processing of the image data to determine corrected image data, such as by applying corrections to reduce distortion from diffraction effects described in techniques described in this disclosure. The processor 104 may further process the image data to apply corrections or effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

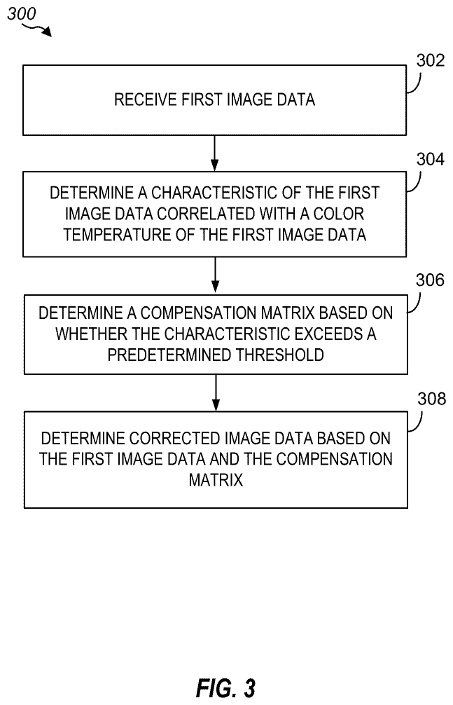

The system 200 of FIG. 2 may be configured to perform the operations described with reference to FIG. 3 to determine output image frames 230. FIG. 3 shows a flow chart of an example method 300 for processing image data to determine corrected image data that removes a diffraction pattern included in the image data according to some embodiments of the disclosure. The diffraction pattern may be the result of the blades of a camera's variable aperture that is used to capture the image data because the variable aperture that approximates a circular opening is not a completely circular opening. The processing in FIG. 3 may obtain an improved digital representation of a scene, which results in a photograph or video with higher image quality (IQ).

At block 302, first image data is received, such as from the camera 103 or from a memory storing image data. In some examples, sensor data regarding a scene represented by the first image data may additionally be received from a sensor (e.g., image sensor and/or depth sensor), such as while the sensor is configured with the camera configuration. The first image data may be received at ISP 112, processed through an image front end (IFE) and/or an image post-processing engine (IPE) of the ISP 112, and stored in memory. In some embodiments, the capture of image data may be initiated by a camera application executing on the processor 104, which causes camera control 210 to activate capture of image data by the camera 103, and cause the image data to be supplied to a processor, such as processor 104 or ISP 112.

At block 304, a characteristic of the first image data correlated with a color temperature of the first image data is determined. In various embodiments, the characteristic may be the color temperature of the first image data or another suitable proxy correlated with color temperature. In at least some aspects, the characteristic of the first image data is based on the received sensor data. For example, the sensor data output by some image sensors (e.g., a spectrum sensors) includes red, green, blue, infrared (IR), and correlated color temperature (CCT) channels and separates the visible light spectrum to only red, green, and blue channels. In some aspects of this example, the characteristic of the first image data correlated with the color temperature of the first image data is determined based on CCT channel information. In other aspects of this example, the characteristic of the first image data correlated with the color temperature of the first image data is determined based on a ratio, such as a ratio of IR channel intensity to red channel intensity (intensity_{IR}/intensity_{red}).

In another example, the sensor data output by some image sensors (e.g., multi-spectrum sensors) includes red, green, blue, infrared (IR), and correlated color temperature (CCT) channels and separates the visible light spectrum into an array of channels (e.g., six channels including blue, cyan, green, chartreuse green, orange, and red). In some embodiments using multi-spectrum sensors, the characteristic of the first image data correlated with the color temperature of the first image data is determined based on CCT channel information. In other example embodiments, the characteristic of the first image data correlated with the color temperature of the first image data is determined based on a ratio of IR channel intensity to red channel intensity (intensity_{IR}/intensity_{red}). The ratio may alternatively be based on multiple channels, such as by summing channels representing red peaks. For example, a sum of the orange channel intensity and the red channel intensity may represent the red channel peaks, wherein the ratio may be represented by the formula:

intensity_{IR}/(intensity_{orange}+intensity_{red})).

In other examples, the sensor data may include data from a depth sensor, such as an indirect time-of-flight (iToF) sensor or a laser sensor. In such embodiments, the characteristic can be determined using both the CCT channel information and an intensity of the depth sensor signal.

At block 306, a compensation matrix is determined by evaluating one or more rules, such as by determining whether the determined characteristic exceeds a predetermined threshold. At least two predefined compensation matrices may be stored in the memory of the camera 103 that correspond to different color temperatures and different known diffraction patterns. In an example, if the ratio intensity_{IR}/intensity_{red} determined at block 304 exceeds a predetermined threshold (e.g., the ratio is greater than 1) then the method includes selecting a first predefined compensation matrix stored in the memory and corresponding to a first color temperature. Conversely, if the ratio intensity_{IR}/intensity_{red} determined at block 304 fails to exceed the predetermined threshold (e.g., the ratio is less than or equal to 1) then the method includes selecting a second predefined compensation matrix stored in the memory and corresponding to a second color temperature. In aspects in which more than two predefined compensation matrices are stored in the memory, the characteristic determined at block 304 may be compared to multiple, different predetermined thresholds in order to select between the stored predefined compensation matrices. Each of the stored and predefined compensation matrices correspond to a respective diffraction pattern that can result in the image data due to the blades of a variable aperture for different light sources with different CCTs.

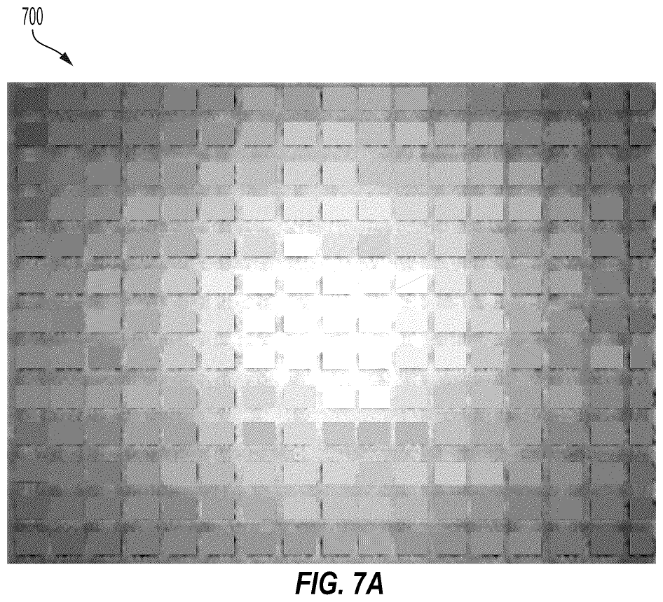

FIG. 6 illustrates an example compensation matrix 600 including multiple values 602. The values 602 of the compensation matrix 600 include values for reducing or eliminating a diffraction pattern in the first image data, such as a starburst pattern in which a distance between the peaks of the starburst pattern correspond to diffraction points on blades of a variable aperture, at a particular CCT corresponding to a particular light source. For example, the cells 602 of the compensation matrix 600 include correction values for reducing red channel peaks, or other artifacts resulting from diffraction off of a blade of a variable aperture, in the first image data. The red channel peaks are correlated with diffraction points from the variable aperture blades. In various examples, each cell may include a luma offset value to apply (e.g., add or subtract) to one or more channels in the image data, or may include unitless ratios to apply (e.g., multiply or divide) to one or more channels in the image data. Each value 602 of the compensation matrix 600 corresponds to a pixel, or a set of pixels (e.g., a block of cell), in the image data. For example, a group of nine bordering pixels in the image data may all receive a correction based on one value 602 in the compensation matrix 600, such that the compensation matrix 600 is a downsampled resolution of the image data. In another example, the image data may be downsampled so that the diffraction pattern in the image data may be analyzed, and then the compensation matrix 600 may be upsampled and used to compensate for the diffraction pattern in the full size image.

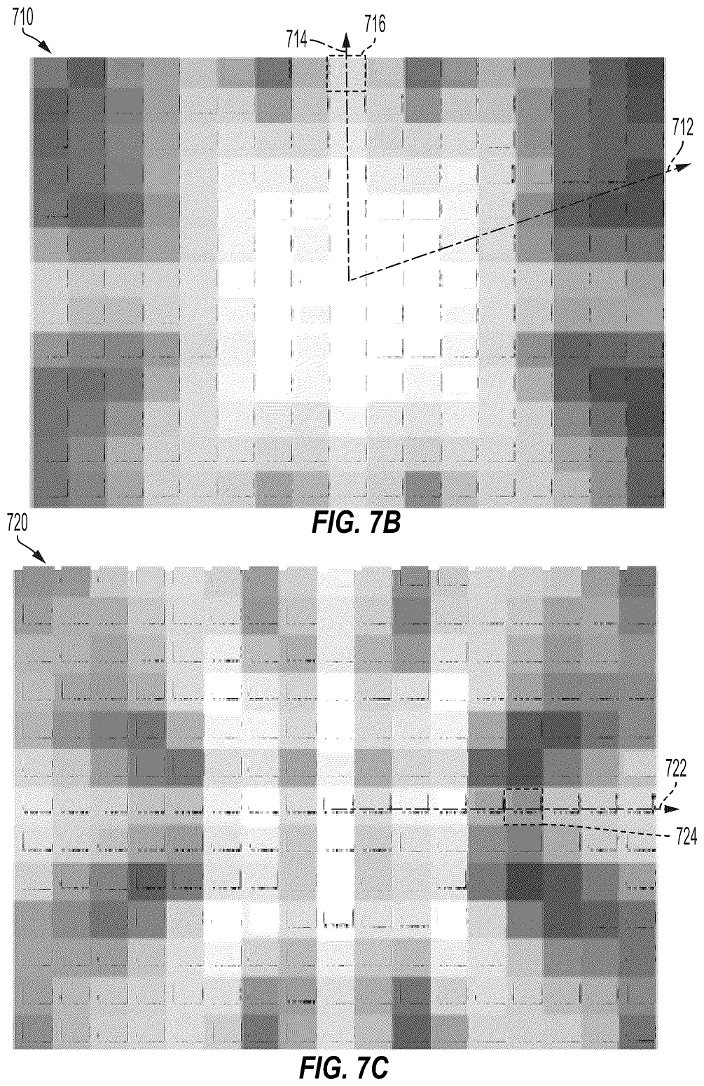

FIG. 7A illustrates a matrix 700 of values (e.g., luma values), denoted by shading, that correspond to the red/green channel of image data that is free of a diffraction pattern caused by blades of a variable aperture. The lighter the shading of a region, the closer the corresponding values of the region are to a minimum value for a region of the image data, whereas the darker the shading of a region, the close the corresponding values of the region are to a maximum value for a region of the image data. As shown in FIG. 7A, for image data without a diffraction pattern, the transition from values near the minimum value to values near the maximum value is smooth in all directions from the center of the image data towards the outermost portion (e.g., corners) of the image data.

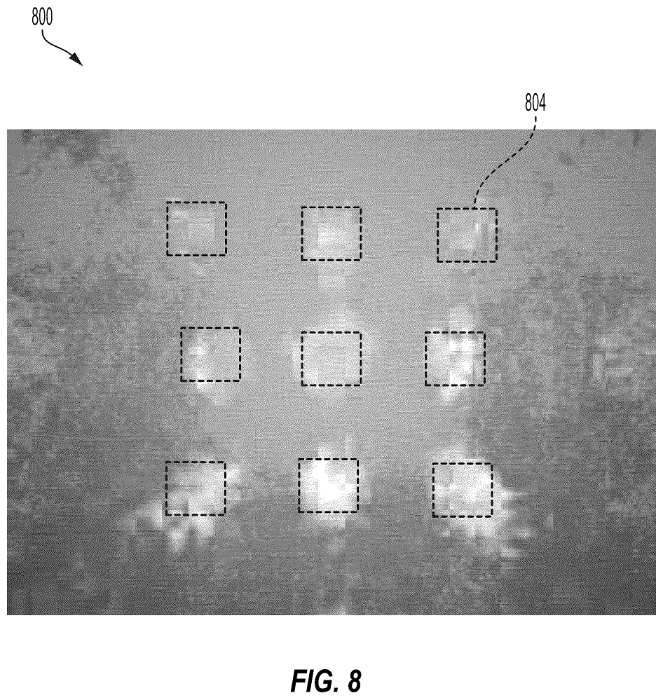

Conversely, FIGS. 7B and 7C illustrate matrices 710 and 720 of values (e.g., luma values), denoted by shading, that corresponds to the red/green channel of respective image data having a first and second diffraction pattern, respectively, in the image data. Some aspects of the present disclosure may utilize channels other than the red/green channel to define and correct diffraction patterns. As shown in FIG. 7B, the transition from values near the minimum value at the center of the image data to values near the maximum value at the outermost portion of the image data is smooth in some regions (e.g., along the arrow 712), but is absent or uneven in other regions (e.g., along the arrow 714). As shown in FIG. 7C, the transition from values near the minimum value at the center of the image data to values near the maximum value at the outermost portion of the image data is uneven in all regions of the image data. For instance, along the arrow 722 starting from the center of the image data, the values increase, decrease, increase, and decrease again. The uneven transitions in the matrices 710 and 720 can indicate that the image data corresponding to the matrices 710 and 720 includes a diffraction pattern that will be visible in a displayed scene represented by the image data. An example diffraction artifact corresponding to values in the matrix 720 is shown in FIG. 8. FIG. 8 shows artifact peaks 804 corresponding to the diffraction pattern included in the matrix 720.

A diffraction pattern is complex and difficult to capture by mathematical formula, but the appearance of the diffraction pattern can be reduced or eliminated from the scene represented by the image data by using the predefined compensation matrices stored in the memory of the camera 103. Each of the predefined compensation matrices are predefined with values that are used to alter values in captured image data to reduce or eliminate the appearance of a known diffraction pattern in a displayed scene represented by the captured image data. For example, the values in the matrix 710 correspond to a first known diffraction pattern resulting from a first type of light source, and a first predefined compensation matrix includes values that are used to alter the values in the matrix 710 to reduce or eliminate the appearance of the first known diffraction pattern in a displayed scene represented by the captured image data. For example, the values of the first predefined compensation matrix may alter the values in the matrix 710 such that the transitions from values near the minimum value at the center of the image data to values near the maximum value at the outermost portion of the image data are smooth in every region of the matrix 710, or at least smooth in a number of regions greater than a threshold. For example, the first compensation matrix may include a value that increases (e.g., via addition or multiplication) the value 716 in the matrix 710. The value 716 is a peak that must be reduced to smooth out the transition in values along the arrow 714. Other values along the arrow 714 may also be increased or decreased based on values in the first predefined compensation matrix to smooth out the transition. In some aspects, the first predefined compensation matrix may be used to alter values of the image data directly rather than altering values of the matrix 710 that is then used to alter values of the image data.

In another example, the values in the matrix 720 correspond to a second known diffraction pattern resulting from a second type of light source, and a second predefined compensation matrix includes values that are used to alter the values in the matrix 720 to reduce or eliminate the appearance of the second known diffraction pattern in a displayed scene represented by the captured image data. For example, the values of the second predefined compensation matrix may alter the values in the matrix 720 such that the transitions from values near the minimum value at the center of the image data to values near the maximum value at the outermost portion of the image data are smooth in every region of the matrix 720, or at least in a number of regions greater than a threshold. For example, the second compensation matrix may include a value that decreases (e.g., via subtraction or division) the value 724 in the matrix 720. The value 724 is a peak that must be reduced to smooth out the transition in values along the arrow 722. Other values along the arrow 722 are also increased or decreased based on values in the second predefined compensation matrix to smooth out the transition. In some aspects, the second predefined compensation matrix may be used to alter values of the image data directly rather than altering values of the matrix 720 that is then used to alter values of the image data.

Returning to block 306, in some embodiments, one of the stored predefined compensation matrices is selected for applying to the image data. In other embodiments, determining the compensation matrix involves determining a new compensation matrix based on the first and second predefined compensation matrices, such as by interpolating a correction matrix between predefined compensation matrices. To illustrate, each predefined compensation matrix may be associated with a predefined value (e.g., 5 for a first predefined compensation matrix and 0.5 for a second predefined compensation matrix) of the characteristic (e.g., the ratio intensity_{IR}/intensity_{red}) of the first image data. If the determined characteristic of the first image data is equal to the predefined value of the first or second predefined compensation matrix (i.e. 5 or 0.5), then the compensation matrix selected for correction is the first or second predefined compensation matrix.

Alternatively, if the determined characteristic of the first image data is between the bounds of the predefined values (e.g., less than 5 and greater than 0.5), then a compensation matrix is determined based on at least one of the first and second predefined compensation matrices. In some embodiments, if the determined characteristic of the first image data is less than the predefined value of the first predefined compensation matrix (e.g., 5), but still greater than a predetermined threshold (e.g., 1), such as a value of 3, then a compensation matrix is determined based on the first predefined compensation matrix. For example, the compensation matrix may be determined by multiplying each value in the first predefined compensation matrix by a ratio of the determined characteristic value to the predefined characteristic value of the first predefined compensation matrix (e.g., a ratio of ⅗). Similarly, if the determined characteristic of the first image data is greater than the predefined value of the second predefined compensation matrix (e.g., 0.5), but still less than the predetermined threshold (e.g., 1), such as a value of 0.75, then a compensation matrix is determined based on the second predefined compensation matrix. For example, the compensation matrix may be determined by multiplying each value in the second predefined compensation matrix by a ratio of the determined characteristic value to the predefined characteristic value of the first predefined compensation matrix (e.g., a ratio of 0.75/0.5). In other example embodiments, a compensation matrix may be determined by interpolating matrix values based on the determined characteristic value and the predefined characteristic values of the first and second predefined compensation matrices.

In some embodiments, the determined characteristic of the first image data may have a value outside the bounds of the predefined values of the predefined compensation matrices. For example, the determined characteristic may have a value greater than 5 or less than 0.5, to continue the above example. In such instances, a compensation matrix is determined from a self-calibration process. The self-calibration process involves determining matrix values (e.g., first channel values) for an image captured with a first aperture value (e.g., f/4.0), determining matrix values (e.g., second channel values) for an image captured with a second aperture value (e.g., f/1.4), and iterating back and forth between capturing images with the two aperture values multiple times. Because the diffraction pattern described herein is more distortive for larger aperture values, the iteration between a smaller aperture value and a larger aperture value allows for determining a ground truth with the matrix values of the smaller aperture value and letting the matrix values of the larger aperture value determine the output of the self-calibration process relative to the matrix values of the smaller aperture value. For example, a compensation matrix determined from the self-calibration process may be determined from a ratio of each of the cell values of the matrix of the larger aperture value to each of the respective cell values of the matrix of the smaller aperture value (e.g., luma values_{f/}4.0/luma values_{f/}1.4) for each of the corresponding cells). In other examples, a compensation matrix may be determined from the iterative matrix values using other suitable methods. In some embodiments, the predefined compensation matrices may be determined using such a self-calibration process.

At block 308, corrected image data is determined based on the first image data and the compensation matrix determined at block 306. The compensation matrix is used to correct the first image data based on the correction values to reduce artifacts resulting from the diffraction pattern in the first image data. For example, a correction value of the compensation matrix may be added to, subtracted from, or multiplied with pixel values (e.g., values of a red, green, or blue channel) of the first image data that correspond to the cell, which may be done for every value in the compensation matrix. In another example, pixel values (e.g., values of a red, green, or blue channel) of the first image data may be multiplied by a correction value of the compensation matrix that corresponds to the pixel values, which may be done for every cell in the compensation matrix.

Referring back to FIG. 2, image frames 230 may be determined by the processor 104 or ISP 112 according to the correction techniques as described according to embodiments herein and stored in memory 106. The stored image frames may be read by the processor 104 and used to form a preview display on a display of the device 100 and/or processed to form a photograph for storage in memory 106 and/or transmission to another device.

In some embodiments, method 300 includes detecting an aperture size (or aperture value) of an image capture device (e.g., camera 103) used to capture the first image data, such as the aperture size of a variable aperture. For example, aperture size data may be included in the first image data received at block 302, or may be detected from data separate from the first image data. In such embodiments, based on the detected aperture size, blocks 304-308 are only performed, in some aspects, if the image data is captured with an aperture size smaller than or equal to a threshold aperture size, or stated differently, at an aperture value greater than a threshold aperture value (e.g., f/4.0).

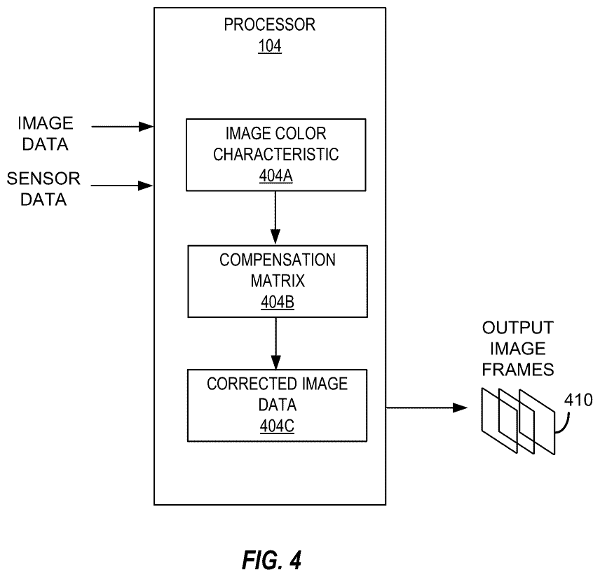

FIG. 4 is a block diagram illustrating an example processor configuration for image data processing in an image capture device according to one or more embodiments of the disclosure. The processor 104, or other processing circuitry, may be configured to operate on image data to perform one or more operations of the method of FIG. 3. The image data may be processed to determine one or more output image frames 410.

At block 404A, the processor 104 determines an image color characteristic of received image data. For example, the processor 104 may determine a characteristic of the received image data that is correlated with a color temperature of the image data. In various aspects, the processor 104 determines the value of the characteristic based on sensor data received from at least one sensor (e.g., an image sensor and/or depth sensor).

At block 404B, the processor 104 determines a compensation matrix based on the value of the determined characteristic of the image data. For instance, using the value of the determined characteristic, the processor 104 determines the compensation matrix based on two predefined compensation matrices stored in memory. Each of the predefined compensation matrices may be associated with a predefined value of the characteristic that the value of the determined characteristic of the image data is compared against as part of the compensation matrix determination.

At block 404C, the processor 104 determines corrected image data based on the received image data and the determined compensation matrix. The processor 104 uses the compensation matrix to correct the received image data in order to reduce the appearance of a diffraction pattern present in the received image data. For example, the values in the cells of the compensation matrix may be added, subtracted, multiplied, divided, etc. with the values in the received image data that correspond to the each of the respective cells of the compensation matrix. The corrected image data has a higher image quality than the received image data. The processor 104 may output the corrected image data as one or more output frames 410.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to receive first image data from a camera comprising a variable aperture; determine a characteristic of the first image data correlated with a color temperature of the first image data; and determine a compensation matrix based on whether the characteristic exceeds a predetermined threshold. The compensation matrix comprises correction values for reducing one or more artifacts in the first image data resulting from blades of the variable aperture. The apparatus is further configured to determine corrected image data based on the first image data and on the compensation matrix.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include a sensor. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to receive sensor data regarding a scene represented by the first image data, wherein the characteristic of the first image data is based on the sensor data.

In a third aspect, in combination with one or more of the first aspect or the second aspect, the sensor data comprises data from at least one of an infrared sensor, a spectrum sensor, a multi-spectrum sensor, a laser sensor, or a time-of-flight sensor.

In a fourth aspect, in combination with one or more of the first aspect through the third aspect, determining the characteristic of the first image data comprises determining a ratio between a first intensity value of a first channel and a second intensity value of a second channel.

In a fifth aspect, in combination with one or more of the first aspect through the fourth aspect, the first intensity value of the first channel corresponds to infrared light and the second intensity value of the second channel corresponds to red light.

In a sixth aspect, in combination with one or more of the first aspect through the fifth aspect, determining the compensation matrix based on whether the characteristic exceeds a predetermined threshold comprises selecting one of at least two predefined compensation matrices comprising a first compensation matrix corresponding to a first color temperature and a second compensation matrix corresponding to a second color temperature.

In a seventh aspect, in combination with one or more of the first aspect through the sixth aspect, determining the compensation matrix further comprises determining an interpolated compensation matrix from the one of the at least two predefined compensation matrices that is selected.

In an eighth aspect, in combination with one or more of the first aspect through the seventh aspect, determining the compensation matrix comprises: determining first channel values corresponding to the first image data, wherein the first image data is received from a camera comprising a variable aperture set in a first aperture value; determining second channel values corresponding to second image data, wherein the second image data is received from the camera comprising the variable aperture set in a second aperture value; and determining the compensation matrix based on the first channel values and the second channel values.

In a ninth aspect, in combination with one or more of the first aspect through the eighth aspect, the one or more artifacts in the first image data are red channel peaks in the first image data.

In a tenth aspect, in combination with one or more of the first aspect through the ninth aspect, determining the corrected image data includes reducing the red channel peaks in the first image data, using the compensation matrix, along a line from a center of an image represented by the first image data to an outer edge of the image represented by the first image data.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1, 2, and 4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art will appreciate that one or more blocks (or operations) described with reference to FIGS. 1, 2, and 4 may be combined with one or more blocks (or operations) described with reference to another of the figures. For example, one or more blocks (or operations) of FIG. 4 may be combined with one or more blocks (or operations) of FIGS. 1 and 2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method, comprising:
receiving, by a processor, first image data from a camera comprising a variable aperture;
determining, by the processor, a characteristic of the first image data correlated with a color temperature of the first image data;
determining, by the processor, a compensation matrix based on whether the characteristic exceeds a predetermined threshold, wherein the compensation matrix comprises correction values for reducing one or more artifacts in the first image data resulting from blades of the variable aperture; and
determining, by the processor, corrected image data based on the first image data and on the compensation matrix.

2. The method of claim 1, further comprising: receiving, by the processor, sensor data regarding a scene represented by the first image data, wherein the characteristic of the first image data is based on the sensor data.

3. The method of claim 2, wherein the sensor data comprises data from at least one of an infrared sensor, a spectrum sensor, a multi-spectrum sensor, a laser sensor, or a time-of-flight sensor.

4. The method of claim 1, wherein determining the characteristic of the first image data comprises determining a ratio between a first intensity value of a first channel and a second intensity value of a second channel.

5. The method of claim 4, wherein the first intensity value of the first channel corresponds to infrared light and the second intensity value of the second channel corresponds to red light.

6. The method of claim 1, wherein determining the compensation matrix based on whether the characteristic exceeds the predetermined threshold comprises selecting one of at least two predefined compensation matrices comprising a first compensation matrix corresponding to a first color temperature and a second compensation matrix corresponding to a second color temperature.

7. The method of claim 6, wherein determining the compensation matrix further comprises determining an interpolated compensation matrix from the one of at least two predefined compensation matrices that is selected.

8. The method of claim 1, wherein determining the compensation matrix comprises:
determining first channel values corresponding to the first image data, wherein the first image data is received from a camera comprising a variable aperture set in a first aperture value;
determining second channel values corresponding to second image data, wherein the second image data is received from the camera comprising the variable aperture set in a second aperture value; and
determining the compensation matrix based on the first channel values and the second channel values.

9. The method of claim 1, wherein the one or more artifacts in the first image data are red channel peaks in the first image data.

10. The method of claim 9, wherein determining the corrected image data includes reducing the red channel peaks in the first image data, using the compensation matrix, along a line from a center of an image represented by the first image data to an outer edge of the image represented by the first image data.

11. An apparatus, comprising:
a memory storing processor-readable code; and
at least one processor coupled to the memory, the at least one processor configured to execute the processor-readable code to cause the at least one processor to perform operations including:
receiving first image data from a camera comprising a variable aperture;
determining a characteristic of the first image data correlated with a color temperature of the first image data;
determining a compensation matrix based on whether the characteristic exceeds a predetermined threshold, wherein the compensation matrix comprises correction values for reducing one or more artifacts in the first image data resulting from blades of the variable aperture; and
determining corrected image data based on the first image data and on the compensation matrix.

12. The apparatus of claim 11, wherein the operations further comprise receiving sensor data regarding a scene represented by the first image data, wherein the characteristic of the first image data is based on the sensor data.

13. The apparatus of claim 12, wherein the sensor data comprises data from at least one of an infrared sensor, a spectrum sensor, a multi-spectrum sensor, a laser sensor, or a time-of-flight sensor.

14. The apparatus of claim 11, wherein determining the characteristic of the first image data comprises determining a ratio between a first intensity value of a first channel and a second intensity value of a second channel.

15. The apparatus of claim 14, wherein the first intensity value of the first channel corresponds to infrared light and the second intensity value of the second channel corresponds to red light.

16. The apparatus of claim 11, wherein determining the compensation matrix based on whether the characteristic exceeds the predetermined threshold comprises selecting one of at least two predefined compensation matrices comprising a first compensation matrix corresponding to a first color temperature and a second compensation matrix corresponding to a second color temperature.

17. The apparatus of claim 16, wherein determining the compensation matrix further comprises determining an interpolated compensation matrix from the one of the at least two predefined compensation matrices that is selected.

18. The apparatus of claim 11, wherein determining the compensation matrix comprises:
determining first channel values corresponding to the first image data, wherein the first image data is received from a camera comprising a variable aperture set in a first aperture value;
determining second channel values corresponding to second image data, wherein the second image data is received from the camera comprising the variable aperture set in a second aperture value; and
determining the compensation matrix based on the first channel values and the second channel values.

19. The apparatus of claim 11, wherein one or more artifacts in the first image data are red channel peaks in the first image data.

20. The apparatus of claim 19, wherein determining the corrected image data includes reducing the red channel peaks in the first image data, using the compensation matrix, along a line from a center of an image represented by the first image data to an outer edge of the image represented by the first image data.

21. A non-transitory, computer-readable medium storing instructions that, when executed by a processor, cause the processor to perform operations comprising:
receiving first image data from a camera comprising a variable aperture;
determining a characteristic of the first image data correlated with a color temperature of the first image data;
determining a compensation matrix based on whether the characteristic exceeds a predetermined threshold, wherein the compensation matrix comprises correction values for reducing one or more artifacts in the first image data resulting from blades of the variable aperture; and
determining corrected image data based on the first image data and on the compensation matrix.

22. The non-transitory, computer-readable medium of claim 21, wherein the operations further comprise receiving sensor data regarding a scene represented by the first image data, wherein the characteristic of the first image data is based on the sensor data.

23. The non-transitory, computer-readable medium of claim 21, wherein determining the characteristic of the first image data comprises determining a ratio between a first intensity value of a first channel and a second intensity value of a second channel.

24. The non-transitory, computer-readable medium of claim 23, wherein the first intensity value of the first channel corresponds to infrared light and the second intensity value of the second channel corresponds to red light.

25. The non-transitory, computer-readable medium of claim 21, wherein determining the compensation matrix based on whether the characteristic exceeds the predetermined threshold comprises selecting one of at least two predefined compensation matrices comprising a first compensation matrix corresponding to a first color temperature and a second compensation matrix corresponding to a second color temperature.

26. An image capture device, comprising:
a sensor;
a memory storing processor-readable code; and
at least one processor coupled to the memory and to the sensor, the at least one processor configured to execute the processor-readable code to cause the at least one processor to perform operations including:
receiving first image data from a camera comprising a variable aperture;
receiving sensor data from the sensor regarding a scene represented by the first image data;
determining a characteristic of the first image data based on the sensor data, wherein the characteristic is correlated with a color temperature of the first image data;
determining a compensation matrix based on whether the characteristic exceeds a predetermined threshold, wherein the compensation matrix comprises correction values for reducing one or more artifacts in the first image data resulting from blades of the variable aperture; and
determining corrected image data based on the first image data and on the compensation matrix.

27. The image capture device of claim 26, wherein the sensor is at least one of an infrared sensor, a spectrum sensor, a multi-spectrum sensor, a laser sensor, or a time-of-flight sensor.

28. The image capture device of claim 26, wherein determining the characteristic of the first image data comprises determining a ratio between a first intensity value of a first channel and a second intensity value of a second channel.

29. The image capture device of claim 28, wherein the first intensity value of the first channel corresponds to infrared light and the second intensity value of the second channel corresponds to red light.

30. The image capture device of claim 26, wherein determining the compensation matrix based on whether the characteristic exceeds the predetermined threshold comprises selecting one of at least two predefined compensation matrices comprising a first compensation matrix corresponding to a first color temperature and a second compensation matrix corresponding to a second color temperature.
